(19) United States
(12) Patent Application Publication
(10) Pub. No.: US 2008/0162128 A1
(43) Pub. Date: Jul. 3, 2008

(54) METHOD AND APPARATUS PERTAINING TO THE PROCESSING OF SAMPLED AUDIO CONTENT USING A FAST SPEECH RECOGNITION SEARCH PROCESS

(75) Inventor: Yan Ming Cheng, Inverness, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/617,892

(22) Filed: Dec. 29, 2006

(51) Int. Cl. G10L 15/00

(52) U.S. Cl. 704/231; 704/256; 704/E13.012

(57) ABSTRACT

One provides (101) a plurality of frames of sampled audio content and then processes (102) that plurality of frames using a speech recognition search process that comprises, at least in part, determining whether to search each subword boundary contained within each frame on a frame-by-frame basis. These teachings will also readily accommodate determining whether to search each word boundary contained within each frame on a frame-by-frame basis.

### RELATED APPLICATIONS

This application is related to a U.S. application being filed on the same date, having attorney docket number CML04031HI, entitled METHOD AND APPARATUS PERTAINING TO THE PROCESSING OF SAMPLED AUDIO CONTENT USING MULTI-RESOLUTION SPEECH RECOGNITION SEARCH PROCESS, having inventor Yan Ming Cheng, and assigned to the assignee hereof. The USASN of the related application is unknown at this time.

### TECHNICAL FIELD

This invention relates generally to speech recognition processes and more particularly to speech recognition search processes.

### BACKGROUND

Speech recognition comprises a known area of endeavor. Certain speech recognition processes make use of speech recognition search processes such as, but not limited to, the so-called hidden Markov model-based speech recognition process. This generally comprises use of a statistical model that outputs a sequence of symbols or quantities where speech is essentially treated as a Markov model for stochastic processes commonly referred to as states. An exemplary hidden Markov model might output, for example, a sequence of 39-dimensional real-valued vectors, outputting one of these about every 10 milliseconds.

Such vectors might comprise, for example, cepstral coefficients that are obtained by taking a Fourier transform of a short-time window of sampled speech and de-correlating the spectrum using a cosine transform, then taking the first (most significant) coefficients for these purposes. The hidden Markov model approach will tend to have, for each state, a statistical distribution called a mixture of diagonal or full covariance Gaussians that will characterize a corresponding likelihood for each observed vector.

In many prior art approaches, a conventional speech recognition search requires that boundaries between words, subwords, and the aforementioned states be searched on a regular basis (typically per each frame of sampled audio content). Though indeed an optimal and powerful approach, this frame-by-frame approach to searching for word, subword, and state boundaries also requires considerable computational resources. This need only grows with the depth and richness of the supported vocabulary. As a result, a speech recognition process that employs a speech recognition search process can require enormous computational resources.

Consider, for example, an application setting where each frame represents only about 10 milliseconds of audio content. For a speech recognition process that supports recognition of, say, 50,000 words, it then becomes necessary to search and compare the recognition data as corresponds to each of those 50,000 words for each such frame. This, alone, can require considerable computational capability. These requirements only grow more severe as one considers that such a process also requires a corresponding search for subwords with each such frame.

As a result, such an approach, while often successful to carry out optimal speech recognition, is also often too computationally needy to work well in an application setting where such computational overhead is simply not available. Small, portable, wireless communications devices such as cellular telephones and the like, for example, represent such an application setting. Both available computational capability as well as corresponding power capacity limitations can severely limit the practical usage of such an approach.

### BRIEF DESCRIPTION OF THE DRAWINGS

The above needs are at least partially met through provision of the method and apparatus pertaining to the processing of sampled audio content using a speech recognition search process described in the following detailed description, particularly when studied in conjunction with the drawings, wherein:

FIG. 1 comprises a flow diagram as configured in accordance with various embodiments of the invention;

FIG. 2 comprises a flow diagram as configured in accordance with various embodiments of the invention;

FIG. 3 comprises a schematic state representation as configured in accordance with various embodiments of the invention; and

FIG. 4 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, one provides a plurality of frames of sampled audio content and then processes that plurality of frames using a speech recognition search process that comprises, at least in part, determining whether to search each subword boundary contained within each frame on a frame-by-frame basis. This contrasts sharply with present practice, of course, in that present practice will typically require systematically searching each frame for subword boundaries without any consideration for whether such a search should, in fact, be conducted. These teachings will also readily accommodate determining whether to search each word boundary contained within each frame on a frame-by-frame basis.

These teachings are readily applied in conjunction with the use of subword hidden Markov model state information for each such frame. By one approach, this process can comprise providing likelihood values for each state of the potential subword hidden Markov model on a frame-by-frame basis and selecting a largest one of these values. That largest value can then be processed as a function of a predetermined beam width value with the resultant value then being compared against the likelihood value as corresponds to the exit state of the potential subword hidden Markov model. One can then determine whether to search each subword boundary (or, if desired, each word boundary) contained within that particular frame as a function, at least in part, of this comparison result.

So configured, these teachings permit relatively accurate and high quality speech recognition processing as one might ordinarily expect when using such speech recognition search processes while nevertheless avoiding a considerable amount of computational activity. In particular, in many cases a given frame, processed as per the above teachings, will appear unlikely to in fact contain a boundary of interest and, in that case, such a frame can simply be skipped in this regard. That is, the speech recognition search process can simply skip such a frame and not search each subword boundary (and/or word boundary) as is contained within that frame. This, in turn, permits a given processing platform having only modest capacity and/or capability to nevertheless often successfully carry out a speech recognition search process with successful results.

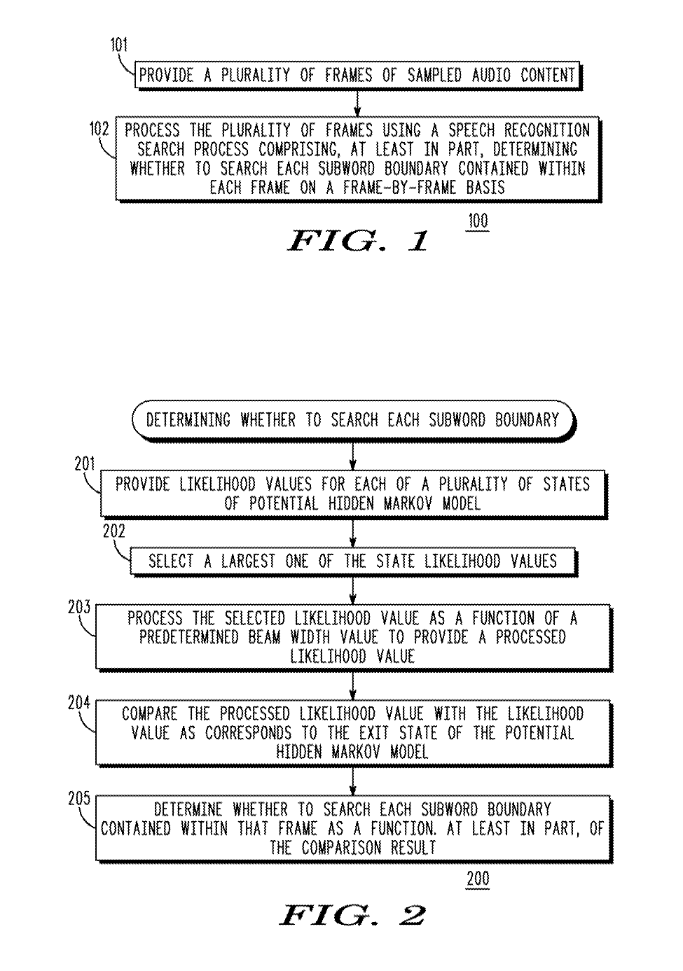

These and other benefits may become clearer upon making a thorough review and study of the following detailed description. Referring now to the drawings, and in particular to FIG. 1, an exemplary process 100 that accords with these teachings first provides 101 a plurality of frames of sampled audio content and then provides for processing 102 those frames using a speech recognition search process that comprises, at least in part, determining whether to search each subword boundary contained within each frame on a frame-by-frame basis. There are various known processes by which such frames can be captured and provided and other processes in this regard are likely to be developed in the future. As these teachings are not overly sensitive to the selection of any particular approach in this regard, for the sake of brevity as well as the preservation of narrative focus further elaboration regarding the provision of such frames will not be provided here save to note that such frames typically only correspond to a relatively brief period of time such as, but not limited to, 10 milliseconds.

The above-mentioned speech recognition search process can comprise such processes as may be suitable to meet the needs of a given application setting. For the purposes of providing an illustrative example and not by way of limitation it will be presumed herein that this speech recognition search process comprises a hidden Markov model-based speech recognition process. Accordingly, the described step of determining whether to search each subword boundary contained within each frame on a frame-by-frame basis will comprise determining whether to search each subword boundary on a frame-by-frame basis as a function, at least in part, of hidden Markov model state information for each of the frames. Such hidden Markov model state information can comprise, for example, likelihood information for each of a plurality of potential hidden Markov model states for each of the frames.

There are various ways by which such a step can be satisfied. As but one illustrative example in this regard, and not by way of limitation, FIG. 2 presents a process 200 that provides for the provision 201 of likelihood values for each of a plurality of states of a potential hidden Markov model and then selecting 202 a largest one of the state likelihood values to provide a resultant selected likelihood value. This selected likelihood value is then processed 203 as a function of a predetermined beam width value (for example, by subtracting the predetermined beam width value from the selected likelihood value) to provide a processed likelihood value that is then compared 204 against a likelihood value as corresponds to a particular state of the potential hidden Markov model (such as the exit state) to thereby provide a resultant comparison result. This process 200 then provides for determining 205 whether to search each subword boundary contained within that frame as a function, at least in part, of the comparison result.

Referring now to FIG. 3, some specific illustrative examples will now be provided. In this example, there are three possible states 300 at time T as corresponds to a given such frame of sampled audio content. These three possible states are denoted here as a beginning state C 301, an exit state A 303, and an in-between state B 302. Each such state 300 has a corresponding likelihood value (for example, state A 303 has likelihood value X while state C 301 has a likelihood value of Z). There are various known ways to determine such likelihood values; accordingly, additional elaboration will not be provided here in this regard. For purposes of these examples, a predetermined beam width of 3 will be presumed. Other values could of course be employed to suit various needs and/or opportunities as might characterize a given application setting.

### EXAMPLE 1

In this example, state A 303 has a value of 1, state B 302 has a value of 2, and state C 301 has a value of 6. Pursuant to these teachings the largest state value (which, in this example, is 6) is selected and the predetermined beam width value is then subtracted therefrom. In this case, that would comprise subtracting 3 from 6, leaving 3 as a processed likelihood value. This processed likelihood value is then compared with a particular one of the potential states 300; in this case, the exit state A 303 which, in this example, has a value of 1. In this example, this comparison comprises determining whether the particular potential state has a value that is less than the processed likelihood value. In this example, then, the inquiry becomes determining whether 1 is less than 3. The latter, of course, in fact represents a true statement. Therefore, a conclusion can be likely drawn for this frame that a subword transition is not likely occurring and that a search of this subword boundary for this frame can be reasonably skipped. If a word boundary occurs at this at this subword boundary, the search of the word boundary can be skipped subsequently. This, in turn, will result in a considerable reduction in computational requirements.

### EXAMPLE 2

In this example, each of the three states 300 has a value of 4. The largest likelihood value is therefore 4 and the predetermined beam width value of 3 is subtracted to yield a processed likelihood value of 1. A comparison in this example therefore reveals that the likelihood value of the exit state A 303 (in this example, a value of 4) is larger than the processed likelihood value of 1. Accordingly, a reasonable conclusion can be drawn that a subword transition may, in fact, be occurring. This, in turn, leads to a determination to search each subword boundary contained within this particular frame. If a word boundary occurs at the subword boundary, a search of the word boundary may be subsequently conducted.

Those skilled in the art will recognize and appreciate that these teachings therefore provide an efficient, simple approach to making a reasonable determination regarding whether a given frame is worth expending computational resources on in order to assess its inclusion of a subword boundary of interest. The overhead computational requirements to support such a decision-making process are relatively modest and more than outweighed by the significant savings to be realized through use and implementation of these processes.

These same teachings can also be applied in conjunction with determining whether to search each word boundary (as versus each subword boundary) within each frame on a frame-by-frame basis (either in lieu of, or in combination with, such a determination as described for subword boundaries).

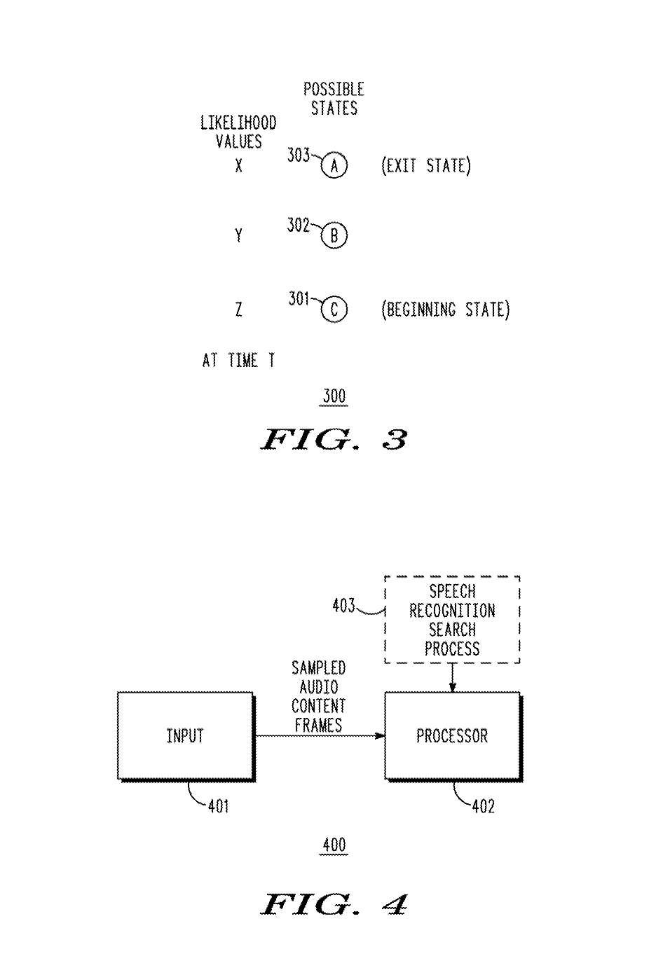

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 4, an illustrative approach to such a platform will now be provided.

In this example, the implementing apparatus 400 comprises an input 401 that operably couples to a processor 402. The input 401 can be configured and arranged to provide a plurality of frames of sampled audio content. Again, there are various known ways by which this can be accomplished that will be readily known and available to a person skilled in the art. The processor 402, in turn, can comprise a dedicated purpose or a partially or wholly programmable platform that is configured and arranged (via, for example, corresponding programming) to effect selected teachings as have been set forth herein. In particular, this processor 402 can be configured and arranged to process the incoming plurality of frames using a speech recognition search process that comprises, at least in part, the aforementioned determination regarding whether to search each subword boundary contained within each frame of the plurality of frames on a frame-by-frame basis.

This speech recognition search process can comprise an integral part of the processor 402 or, if desired, can comprise, for example, a software program 403 that is stored on an available memory or the like. In any event, as noted above, this speech recognition search process can readily comprise a hidden Markov model-based speech recognition process if desired.

Those skilled in the art will recognize and understand that such an apparatus 400 may be comprised of a plurality of physically distinct elements as is suggested by the illustration shown in FIG. 4. It is also possible, however, to view this illustration as comprising a logical view, in which case one or more of these elements can be enabled and realized via a shared platform. It will also be understood that such a shared platform may comprise a wholly or at least partially programmable platform as are known in the art.

So configured, an implementing platform having only modest processing capabilities (such as a cellular telephone or the like) can nevertheless make highly leveraged use of powerful speech recognition search processes by making these selective determinations regarding whether and which frames of sampled audio content to test for subword and/or word boundaries. The described approaches are relatively easy to implement and serve to highly leverage information that is typically already available (such as, for example, the likelihood values for the various possible states for each frame). These teachings are also readily scaled to meet the needs and/or opportunities as correspond to a given application setting. For example, these teachings can be readily applied in use with a speech recognition search process that provides for more than three possible states.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
providing a plurality of frames of sampled audio content;
processing the plurality of frames using a speech recognition search process comprising, at least in part, determining whether to search each subword boundary contained within each frame on a frame-by-frame basis.

2. The method of claim 1 wherein using a speech recognition search process comprises using a hidden Markov model-based speech recognition process.

3. The method of claim 2 wherein determining whether to search each subword boundary contained within each frame on a frame-by-frame basis comprises determining whether to search each subword boundary contained within each frame on a frame-by-frame basis as a function, at least in part, of hidden Markov model state information for each of the frames.

4. The method of claim 3 wherein the hidden Markov model state information comprises likelihood information for each of a plurality of states of a potential hidden Markov model for each of the frames.

5. The method of claim 4 wherein determining whether to search each subword boundary contained within each frame on a frame-by-frame basis as a function, at least in part, of hidden Markov model state information for each of the frames comprises, at least in part and for each of the frames:
providing likelihood values for each of a plurality of states of a potential hidden Markov model;
selecting a largest one of the likelihood values to provide a selected likelihood value;
processing the selected likelihood value as a function of a predetermined beam width value to provide a processed likelihood value;
comparing the processed likelihood value with the likelihood value as corresponds to a particular state of the potential hidden Markov model to provide a comparison result;
determining whether to search each subword boundary contained within that frame as a function, at least in part, of the comparison result.

6. The method of claim 5 wherein processing the selected likelihood value as a function of a predetermined beam width value to provide a processed likelihood value comprises subtracting the predetermined beam width value from the selected likelihood value to provide the processed likelihood value.

7. The method of claim 1 wherein processing the plurality of frames using a speech recognition search process further comprises, at least in part, determining whether to search each word boundary contained within each frame on a frame-by-frame basis based on knowledge of whether a corresponding subword boundary, which comprises a last subword of a given word, has been searched.

8. An apparatus comprising:
an input configured and arranged to receive a plurality of frames of sampled audio content;
processor means operably coupled to the input for processing the plurality of frames using a speech recognition search process comprising, at least in part, determining whether to search each subword boundary contained within each frame on a frame-by-frame basis.

9. The apparatus of claim 8 wherein the processor means uses a speech recognition search process by using a hidden Markov model-based speech recognition process.

10. The apparatus of claim 9 wherein the processor means determines whether to search each subword boundary contained within each frame on a frame-by-frame basis by determining whether to search each subword boundary contained within each frame on a frame-by-frame basis as a function, at least in part, of hidden Markov model state information for each of the frames.

11. The apparatus of claim 10 wherein the hidden Markov model state information comprises likelihood information for each of a plurality of states of a potential hidden Markov model for each of the frames.

12. The apparatus of claim 11 wherein the processor means determines whether to search each subword boundary contained within each frame on a frame-by-frame basis as a function, at least in part, of hidden Markov model state information for each of the frames by, at least in part and for each of the frames:
providing likelihood values for each of a plurality of states of a potential hidden Markov model;
selecting a largest one of the likelihood values to provide a selected likelihood value;
processing the selected likelihood value as a function of a predetermined beam width value to provide a processed likelihood value;
comparing the processed likelihood value with the likelihood value as corresponds to a particular state of the potential hidden Markov model to provide a comparison result;
determining whether to search each subword boundary contained within that frame as a function, at least in part, of the comparison result.

13. The apparatus of claim 12 wherein processing the selected likelihood value as a function of a predetermined beam width value to provide a processed likelihood value comprises subtracting the predetermined beam width value from the selected likelihood value to provide the processed likelihood value.

14. An apparatus comprising:
an input configured and arranged to provide a plurality of frames of sampled audio content;
a processor operably coupled to the input and being configured and arranged to process the plurality of frames using a speech recognition search process that comprises, at least in part, determining whether to search each subword boundary contained within each frame on a frame-by-frame basis.

15. The apparatus of claim 14 wherein the processor is further configured and arranged to use a speech recognition search process by using a hidden Markov model-based speech recognition process.

16. The apparatus of claim 15 wherein the processor is further configured and arranged to determine whether to search each subword boundary contained within each frame on a frame-by-frame basis by determining whether to search each subword boundary contained within each frame on a frame-by-frame basis as a function, at least in part, of hidden Markov model state information for each of the frames.

17. The apparatus of claim 16 wherein the hidden Markov model state information comprises likelihood information for each of a plurality of states of a potential hidden Markov model for each of the frames.

18. The apparatus of claim 17 wherein the processor is further configured and arranged to determine whether to search each subword boundary contained within each frame on a frame-by-frame basis as a function, at least in part, of hidden Markov model state information for each of the frames by, at least in part and for each of the frames:
providing likelihood values for each of a plurality of states of a potential hidden Markov model;
selecting a largest one of the likelihood values to provide a selected likelihood value;
processing the selected likelihood value as a function of a predetermined beam width value to provide a processed likelihood value;
comparing the processed likelihood value with the likelihood value as corresponds to a particular state of the potential hidden Markov model to provide a comparison result;
determining whether to search each subword boundary contained within that frame as a function, at least in part, of the comparison result.

19. The apparatus of claim 18 wherein processing the selected likelihood value as a function of a predetermined beam width value to provide a processed likelihood value comprises subtracting the predetermined beam width value from the selected likelihood value to provide the processed likelihood value.

20. The apparatus of claim 14 wherein the processor is further configured and arranged to process the plurality of frames using a speech recognition search process by, at least in part, determining whether to search each word boundary contained within each frame on a frame-by-frame basis base on knowledge of whether a corresponding subword boundary, comprising a last subword of a given word, has been searched.
